(19) United States
(12) Patent Application Publication
(10) Pub. No.: US 2004/0205807 A1
(43) Pub. Date: Oct. 14, 2004

(54) Flexible airfoil ring for safely flying CD's and DVD's

(76) Inventors: Cynthia Harland Wilcoxson, Fortuna, CA (US); Don Gary Harland, Fortuna, CA (US)

Correspondence Address: CYNTHIA HARLAND WICOXSON, DON G. HARLAND, 1159 VISTA DRIVE, FORTUNA, CA, 95540, US

(21) Appl. No.: 10/308,405

(22) Filed: Dec. 3, 2002

(51) Int. Cl. G11B 3/70; G11B 5/84; G11B 7/26; A63H 27/00; A63B 65/10; A63B 67/06; A63B 67/14

(52) U.S. Cl. 720/720; 369/273; 446/46; 446/48; 473/588; 473/589

(57) ABSTRACT

An annular protective rim attachment designed to grip the outer peripheral edge of compact discs (CD's) and digital video discs (DVD's), consisting of a flexible, flat top rim (10), the inner periphery of which is molded to form an upper lip (12), lower lip (14), and between these lips, a gripping mouth (16) to securely hold the CD or DVD (28) inside the aperture of said ring. The underside of said ring is shaped in such a way as to create an airfoil (20) adequate to enable the airfoil ring with attached CD or DVD (28) to safely fly and exhibit controllability when tossed into the air. The airfoil ring is made of a soft, flexible non-malleable plastic material which will create a cushioning effect so as not to produce contact impact and resultant injury or damage when tossed into the air.

### CROSS-REFERENCE TO RELATED APPLICATIONS

Not applicable.

### BACKGROUND—DESCRIPTION OF PRIOR ART

This invention relates to the use of compact discs (CD's) and digital video discs (DVD's) in the fields of advertising, mass distribution and toys, specifically in making their use safer for consumers and more profitable for advertisers.

A number of patents refer to the use of a foam or other plastic ring designed to fit around the perimeter of a flying disc, most with the purpose of giving the disc aerodynamic characteristics.

U.S. Pat. No. 5,366,403 refers to a foam ring designed to fit around a disposable paper or plastic dinner plate. The shape of the plate itself creates the airfoil, and varies, aerodynamically, based on the shape of the particular plate used and the manner by which it is inserted. The foam ring serves as a protective surface. It is not an integral component of the airfoil.

U.S. Pat. No. 4,351,129 refers to a flying disc wherein a circular, clear insert is permanently attached across the center aperture of the annular disc, using a series of corresponding holes and pegs attached in a fusing process. This disc is constructed using a rigid plastic.

U.S. Pat. No. 4,940,441 refers to an aerodynamic disc wherein a weighted insert is attached to the inside perimeter of a plastic ring via threading on both pieces.

U.S. Pat. No. 4,176,843 refers to a two-piece disc, bonded together, with a solid, flat center.

U.S. Pat. No. 3,900,986 refers to an aerodynamic unit with air-activated whistle elements positioned around the periphery.

The above are patents that refer to a foam, PVC, or other plastic ring encircling a disc such as a paper plate, or flat plastic circle. However, none of the references show a ring shaped to fit annularly on the edge of a CD or DVD. In addition, none are shaped to create an airfoil in conjunction with the flat surface of a CD or DVD. U.S. Pat. No. 5,366,403 shows possible aerodynamic characteristics, but the airfoil is created by the paper plate and not dependent on the ring itself. Moreover, none show the use of a combination of different plastics as part of the annular rim, a soft porous plastic for safety and a more rigid plastic for stability.

### BACKGROUND OF THE INVENTION

Compact discs (CD's) are commonly used for mass distribution advertising, marketing products, product catalogs, software distribution, recorded music, data storage, hard drive storage, and digital graphic cataloging and storage. They also have a growing and unlimited number of other uses. Digital video discs (DVD's) are becoming the preferred medium for distribution of movies, both for sale to consumers and rentals. Because CD's and DVD's are inexpensive and easy to distribute, hundreds of millions have been produced and distributed, and the number is steadily increasing. CD's and DVD's have also become the preferred method for data storage for businesses and other institutions of all sizes.

The development of CD-DVD Read/Write drives, commonly known as CD burners, has enabled consumers to use CD's and DVD's to store computer files, copy their own music recordings, copy movies, and for, potentially, a myriad of other uses. Millions of blank CD's are already being manufactured and sold for storage and duplication.

Many companies such as Internet Service Providers (ISP's) send millions of CD's to consumers through the mail. The CD's contain all the tools and software necessary to subscribe to that particular ISP. Other companies, such as software mail order companies send their catalogs out to consumers in the form of CD's. These mass mailings have become increasingly more common, to the point that consumers often consider them to be in the same category as junk mail and rapidly discard them. This is highly undesirable for three reasons:

a) Unusable, discarded or obsolete CD or DVD discs are at present a non-degradable waste product.

b) Marketing and advertising dollars are essentially wasted. CD's are in the hands of consumers and in use only a small amount of time, if at all, and are then discarded or tossed onto a shelf and forgotten.

c) Children and adults pick up discarded CD's and use them as toys because of their “flying saucer” shape, They are thrown through the air, often in destructive and injurious ways. The problem of injuries is due to the hard, sharp edges on the perimeter of the CD or DVD. That sharp edge is the first contact surface to hit a person or an object, and quite often hits with substantial impact.

Some people who are actively aware of the need for recycling, reuse CD's by recording over the original material. This is not possible in many instances, and moreover, new blank CD's have become so inexpensive that most people just use new ones rather than go to the trouble of re-recording.

Large sporting events and concerts are seen by advertisers as having great potential for mass distribution of advertising CD's. They are reluctant, though, because large, sometimes boisterous crowds may begin throwing the CD's around like flying saucers because they fly fairly well. The edges of CD's are hard and sharp, which could cause serious injuries.

The same is true at the home level. The round, flat shape of CD's gives them a degree of lift, creates a rudimentary airfoil, and makes them conducive to flight. Because of that capability, it is natural to pick them up and throw them through the air. They are commonly tossed and flown by both children and adults. They fly easily, and can be tossed fairly accurately at targets. But the issues of serious injury and of damage to furniture, walls, and anything else in their paths, still remain a substantial problem for the following reasons:

a) CD and DVD discs, in their present form, must travel through the air at high speeds in order to stay aloft.

b) By design, there is nothing to keep the CD or DVD disc traveling horizontally through the air. They twist and turn and slam hard into whatever they hit, creating high contact forces due to a very small and sharp contact area on the outer edge of the disc.

### BRIEF SUMMARY OF THE INVENTION

A circular soft plastic ring designed to grip a CD or DVD securely within its aperture, and, in combination with that CD or DVD, to create an airfoil. The airfoil ring permits a CD or DVD to fly, hover and float, when tossed into the air, without danger of injury or property damage from the hard, sharp peripheral edges of the CD or DVD.

### OBJECTS AND ADVANTAGES

We have used two existing and unrelated common ideas, the airfoil ring and a gripping lip, and combined them for use with the CD or DVD, to create a completely new product. Accordingly, several objects and advantages of our invention are:

(a) to provide a device that, when attached to a CD or DVD, creates an airfoil adequate to give the CD or DVD lift, hoverability and controllability when tossed.

(b) to provide a means for tossing and flying CD's and DVD's in a safe way, inside or outside, significantly decreasing the potential for bodily injury or property damage.

(c) to provide a new use for the millions of CD's and DVD's that are delivered by mail, which are considered “junk mail” and would otherwise be discarded.

(d) to provide a way to recycle the millions of CD's and DVD's, which are non-biodegradable and not easily recyclable, and which are used and discarded, stored and forgotten, or discarded because they are considered useless.

(e) to provide advertisers with a new medium for distributing catalogs, advertising, and any other material or software they wish to have widely circulated-a CD with the soft ring attached can be tossed into the crowd at sporting events, music events, or any other place where large numbers of people gather, without the current problem of potential injuries.

(f) to provide advertisers a means of circulating their advertising or software in a way that it will not end up in the trash, but will continue to be circulated from one consumer to the next. This is advantageous because:

a. the soft ring around the CD can be manufactured in any color. It can have any company or advertiser's trademark, logo, brand, colors, website, phone numbers, or any other desired or pertinent information incorporated directly into the mold at the time of manufacture. It can also be added after manufacture.

b. products of this nature, especially toys with trademarks, often become collectible, and as such, are traded, sold, and often displayed.

c. when tossed into a crowd, the advertising CD's will continue to be circulated by consumers tossing them back and forth, putting them into an ever-increasing number of consumers' hands.

d. when tossed into a crowd, the advertising CD's are not likely to be discarded. Attractive, fun giveaways are much more likely to remain in the hands of the consumer, who will take them home and:

i. by easily removing the CD or DVD from the airfoil ring, the user can insert the CD or DVD into a computer or DVD player and retrieve and use information on the disc as it was intended to be used.

ii. use the advertising CD or DVD with attached soft ring as a toy.

iii. by continuing to toss the CD or DVD with attached soft ring, will keep it in circulation among other consumers.

iv. be kept as a souvenir of the event.

v. be collected or traded.

e. when advertising CD's are used with the attached lipped ring in a way that consumers are less likely to discard them and more likely to keep them circulating, brand name recognition is continually reinforced and advertising dollars are maximized.

(g) to provide a way to turn an item with limited, but essential function (CD or DVD), which is currently only used for data storage and recording, and is then stored or discarded, into a new, safe toy for children and adults, suitable for play in almost any environment, inside or outside, with unlimited new uses such as:

a. tossing the CD or DVD with attached lipped airfoil ring back and forth between two or more people.

b. tossing the CD or DVD with attached lipped airfoil ring at a target or into a target receptacle.

c. tossing the CD or DVD with attached lipped airfoil ring in various ways that cause it to perform stunts and tricks.

d. modifying the lipped airfoil ring in such a way as to cause the CD or DVD with attached soft ring to fly in different patterns, make sounds as it flies, or perform stunts and tricks.

Further objects and advantages will become apparent from a consideration of the drawings and ensuing description.

### DRAWING FIGURES

In the drawings, closely related figures have the same number but different alphabetic suffixes.

FIG. 1A shows a perspective view of the top of the airfoil ring and the top view of the inner lips and gripping mouth.

FIG. 1B shows the same perspective view as in FIG. 1A, but with the CD or DVD inserted between the lips.

FIG. 2A shows a perspective view of the under side of the airfoil ring and the bottom view of the lips and gripping mouth.

FIG. 2B shows the same perspective view as in FIG. 2A, but with the CD or DVD inserted between the lips.

FIG. 3A shows a perspective view of a cross section of the lipped airfoil ring, and specifically the end section with detail of the lips and gripping mouth.

FIG. 3B shows the same perspective view as in FIG. 3, but with the CD or DVD inserted between the lips.

FIGS. 4-8 show perspective views of cross sections of alternative embodiments with modified airfoil rims.

FIG. 9 shows a perspective view of a cross section of an alternative embodiment with modified airfoil rim and different types of lettering that are part of the original mold.

FIG. 9A shows an enlarged view of the types of possible lettering that can be part of the original mold.

FIG. 10 shows a perspective view of cross section of an alternative embodiment with modified airfoil rim and a sample of notches for special effects.

### REFERENCE NUMBERALS IN DRAWINGS

10 top rim

12 upper lip

14 lower lip

16 gripping mouth

18 fused or glued area (underside of top rim and top side of airfoil rim)

20 airfoil rim

22 inside edge of airfoil rim

24 underside of lower lip, top rim and top section

26 outside edge of top rim

28 standard CD or DVD

30 notching

32 raised lettering

34 stamped or laminated lettering

36 recessed lettering

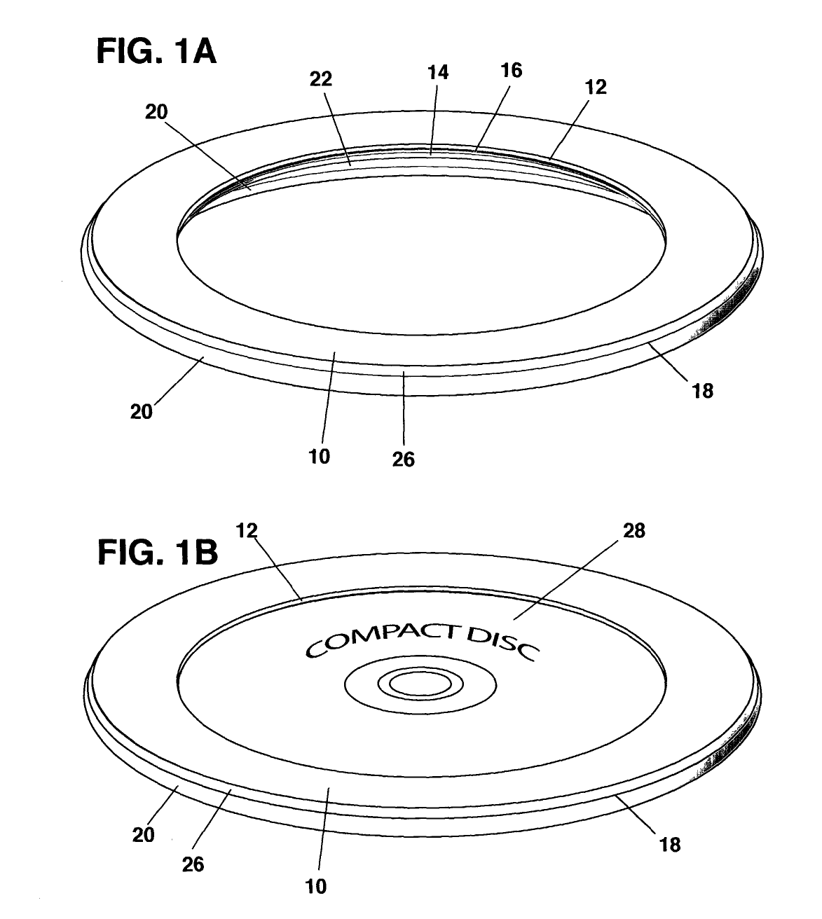

### DESCRIPTION—FIGS. 1A, 1B, 2A, 2B, 3A AND 3B—PREFERRED EMBODIMENT

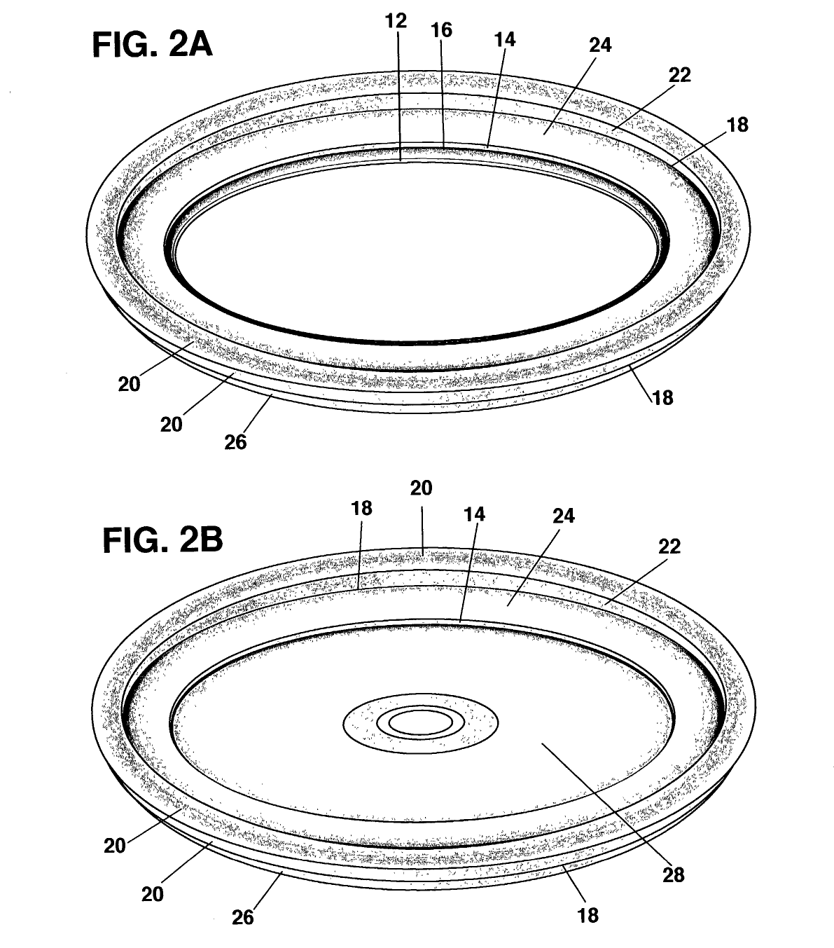

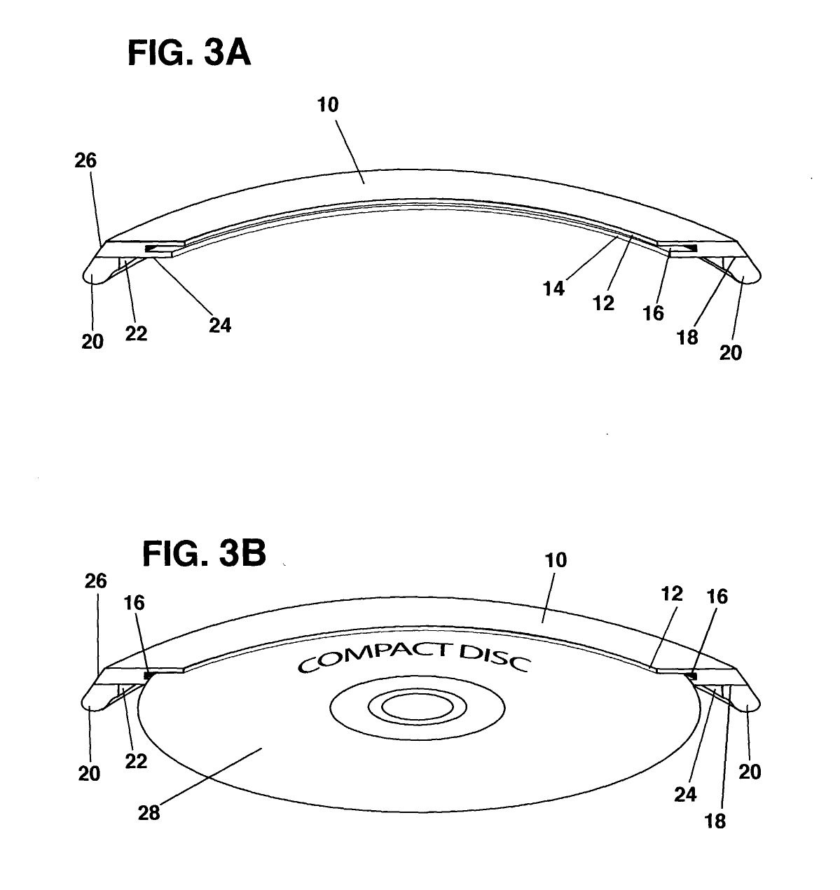

A preferred embodiment of the lipped airfoil ring, the present invention, is illustrated in FIG. 1A (perspective top view) and FIG. 2A (perspective underside view) and FIG. 3A (perspective cross section view). FIGS. 1B, 2B and 3B show this embodiment with a compact disc (CD or DVD) 28 inserted into a gripping mouth 16 as it would be when in use. The lipped airfoil ring is made up of two separate sections, each a different material, permanently fused or adhered together. The top section, FIG. 1A, is the top rim 10, and has, as a part of it, an upper lip 12, a lower lip 14 and a gripping mouth 16. In FIG. 1A, the top rim 10 is a flexible, but not malleable plastic. The bottom section, FIG. 2A, is the airfoil rim 20. It is a light weight, flexible foam plastic. The two sections, top rim 10 and airfoil rim 20 are fused, or adhered, at the surface where the two parts meet 18. Both materials used in the preferred embodiment are available from Radical Elastomers of Langley, British Columbia, Canada. In the preferred embodiment, the materials used are available in several colors. The top rim 10 and the airfoil rim 20 can be molded using the same or different colors. The material used for the top rim 10 can easily be used in a mold with recessed or raised lettering, written information or logo designs. The finished product can then have a raised message or logo for advertising, which can be colored to match or contrast with the top rim 10 color. There are a number of other materials that can be used including polyethylene, polypropylene, various foam products, vinyl, nylon, rubber, leather, various impregnated or laminated fibrous materials, various plasticized material, organic materials, cardboard, etc.

The weight of the preferred embodiment, FIGS. 1A and 2A, is between 20 and 40 grams, but can vary depending on preferred flight characteristics. The weight will vary when alternative materials are used.

In FIGS. 1A and 3A, the top rim 10 is a flexible, but not malleable plastic material. Because it is formed using a mold, it is liquid in its raw form and hardened through a heat process, drying process or aging process, depending upon the properties of the plastic material being used. The diameter of the inner periphery of the top rim 10 is 90 mm to 105 mm. The diameter of the outer periphery is 120 mm to 140 mm across the top of the top rim 10. It can be wider than 140 mm, depending on the desired flight characteristics and materials used. The top rim 10 is typically 2.5 to 5.5 mm thick at its outer edge, from the top surface to the point at which it meets the airfoil rim 20, but can vary. The inner edge of the top rim 10 forms the upper lip 12. At this point on the inner edge of the top rim 10, or upper lip 12, the thickness is 1 mm. This thickness extends back from the inner edge of the top rim 10 (forming the upper lip 12) approximately 7 mm. At that point the top rim thickens to 3 mm. That thickness forms a wall perpendicular to the underside of the upper lip 12. That wall forms the back of the gripping mouth 16 (more visible in FIG. 3A #16).

The back wall of the gripping mouth 16 is 1 mm in height, the approximate thickness of the standard CD or DVD 28. An appendage perpendicular to the back wall of the gripping mouth 16 extends toward the inner periphery of the rim, annularly parallel to the upper lip 12. This appendage is the lower lip 14. The underside 24 of this lower lip (more visible in FIGS. 2A and 3A) extends 15 mm to 25 mm from its inner peripheral edge to its outer peripheral edge. This lower lip underside 24 is also the underside of the entire top section. The fused area 18 is where the airfoil rim meets this underside 24.

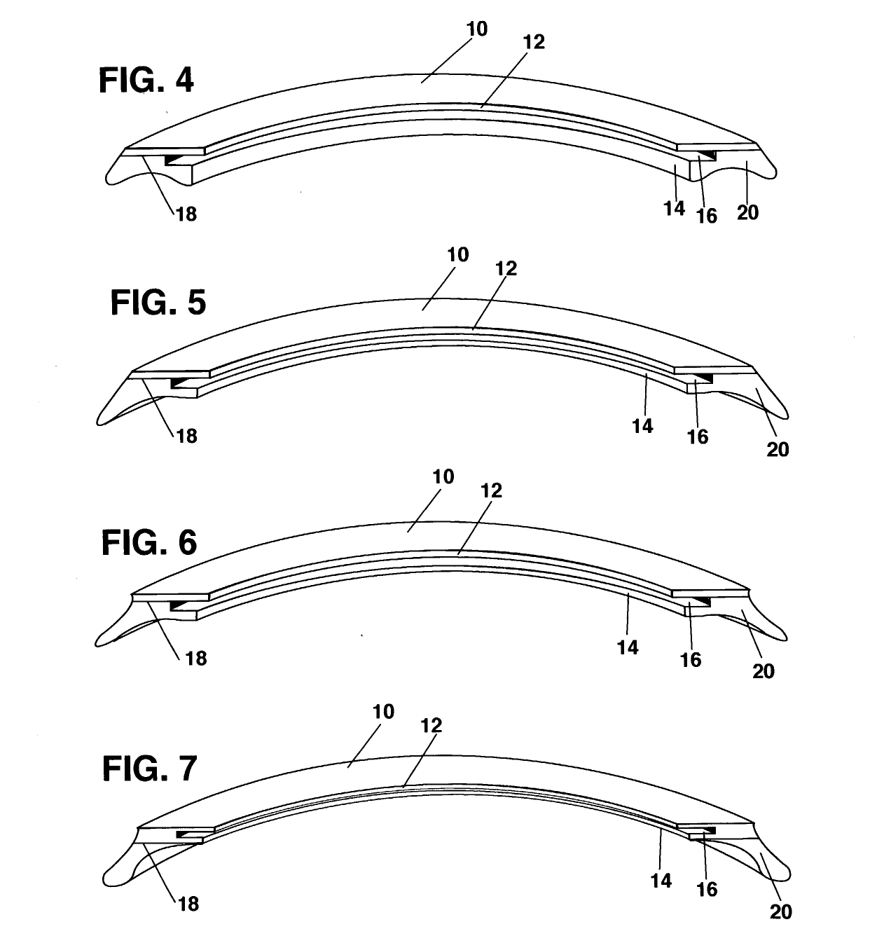

The outer peripheral edge of the top rim 10 is angled outward and downward, FIGS. 1A and 3A, at approximately 55 degrees (exterior angle), an angle which can have a wide variance. The thickness of the outer peripheral edge of the top rim 10 is 3 mm. The angle of the outside edge of the airfoil rim 20, visible in FIGS. 1A and 3A, is the same angle, in this case, 55 degrees, as the outside edge of the top rim 10. The angle or curve of the outside edges of both the top rim 10 and the airfoil rim 20 will vary with alternative embodiments, and with desired flight characteristics, discussed in the description of FIGS. 4-10.

FIG. 3A shows how the upper lip 12 and lower lip 14 form the gripping mouth 16. FIG. 3B shows how the CD or DVD 28 fits into the gripping mouth 16 between the upper lip 12 and the lower lip 14. The lips need to be wide enough to securely hold the CD or DVD 28 even when the lipped airfoil ring hits a hard object when thrown. The upper lip 12 is 3 mm to 9 mm, and lower lip 14 is also 3 mm to 9 mm. The CD or DVD 28 should not become dislodged upon impact or during normal use. The lips 12 and 14 should not be so wide that inserting or removing the CD or DVD 28 from the gripping mouth is difficult. Easy insertion and removal depend on the width of the lips 12 and 14, gripping mouth 16, and flexibility of the material used.

FIG. 2A shows a perspective view of the underside of the lipped airfoil ring. It shows the underside of the top section, comprised of the upper lip 12, gripping mouth 16, lower lip 14, and the underside 24. The fused area 18 is where the airfoil rim 20 meets the underside 24 of the top section. In the preferred embodiment, the airfoil rim 20 is 9 mm to 12 mm thick (inside to outside on a horizontal plane), and 6 mm to 18 mm tall (fuse point 18 to bottom edge) on a vertical plane. An inside edge 22 extends from the inner side of the fused area 18 on the underside 24 perpendicularly toward the bottom of the airfoil rim 20 2 mm to 7 mm. This edge 22 does not need to be perpendicular, as discussed in the descriptions of FIGS. 4-10. This inside edge 22 then curves around to the outside edge of the airfoil rim 20. The outside edge of the airfoil rim 20 can be straight or curved depending on desired flight characteristics. In this embodiment, it is straight and is at an angle of approximately 55 degrees, matching the angle of the outside edge of the top rim 10. The outer peripheral edge of the airfoil rim 20 meets the outer peripheral edge of the top rim at the fuse area 18.

### FIGS. 4-10 Alternative Embodiments

There are numerous and varied possibilities with regard to the relative shape and size of the entire lipped airfoil ring and for each of its sections, the top rim 10 and the airfoil rim 20. All alternative embodiments are the same materials used in the preferred embodiment, a flexible but not malleable plastic for the top rim 10 and a lighter, foam-type plastic for the airfoil rim 20. Several other materials, previously mentioned, may be used. FIGS. 4, 5 and 6 show the top section consisting only of the top rim 10, which forms the upper lip 12. In all three embodiments, the lower lip 14 and the gripping mouth 16 are the result of the shape of the airfoil rim 20. In FIG. 4, the fused area 18 extends approximately halfway to the center of the underside of the top rim 10. At that inside point, a perpendicular wall 1 mm in height descends vertically from the fused area 18 to form the back wall of the gripping mouth 16. The lower lip 14 extends inward 5 mm to 10 mm annularly parallel to the upper lip 12, the lower lip 14 still being a part of the airfoil rim 20. The bottom of the airfoil rim 20 is curved in a concave shape and is 2 mm to 6 mm at the center of the curve and 4 mm to 9 mm thick at the outer side of the curve. The outside edge of the airfoil rim 20 and the outer edge of the top rim 10 form a smooth surface, 8 mm to 15 mm in its entirety, that is angled at approximately 55 degrees (exterior angle from horizontal axis across top rim 10).

FIG. 5 follows the same description as FIG. 4 except for the curve of the bottom of the airfoil rim 20. This curve is also concave, but it extends farther downward so that the entire length of the outside edge of the airfoil rim 20 and the tip rim 10 is 15 mm to 25 mm.

FIG. 6 follows the same description as FIGS. 4 and 5. The difference in FIG. 6 is that the entire outer peripheral edge of the top rim 10 and airfoil rim 20 is also concave.

The top section of FIG. 7 is the same as the description in the preferred embodiment, in that the upper lip 12, gripping mouth 16 and lower lip 14 are molded as one piece. The variance in this embodiment is that the airfoil ring slopes concavely and sharply downward from the fused area 18 under the lower lip 14, curves at the bottom, and then again on the outer edge, curves concavely to the top edge of the top rim 10.

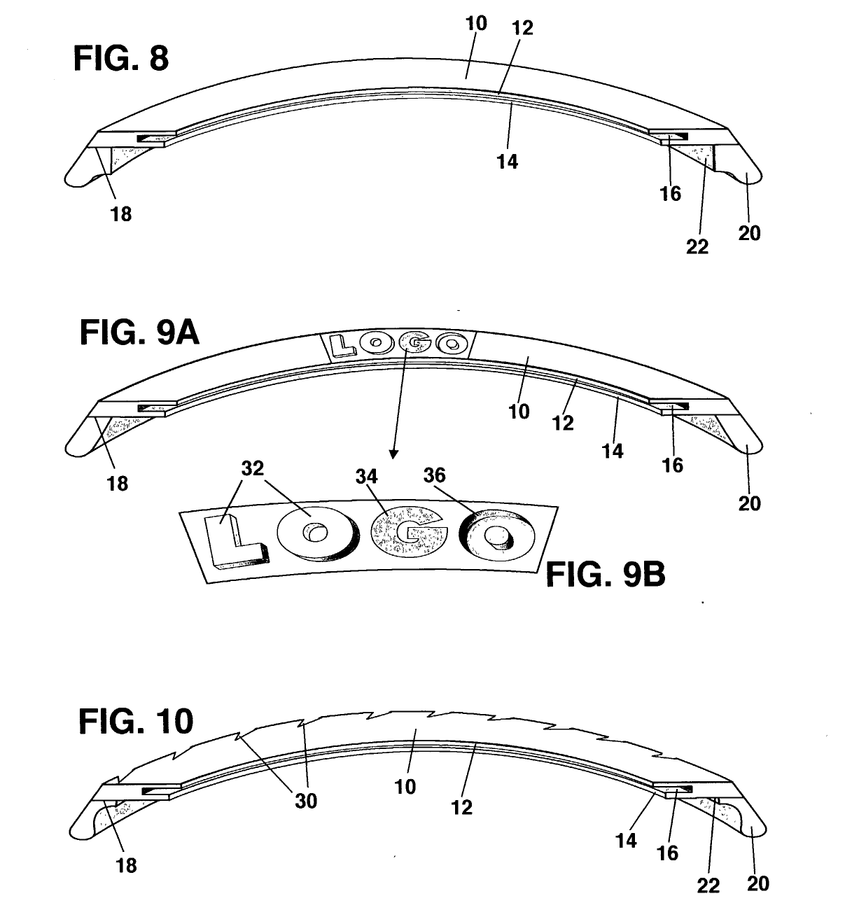

FIG. 8 follows the same description as FIG. 7 except that its airfoil rim curves differently. From the bottom, the airfoil rim 20 curves upward in a concave fashion, but then approximately halfway to the fused area, it abruptly forms a perpendicular inside wall 22 that attaches at the fused area.

The airfoil rim 20 in FIG. 9A is similar to FIG. 7, but has no curves.

FIG. 9B shows an expanded example of lettering that is part of the mold. If the plastic material is liquid in its raw state, letters, numbers or other graphics or logos can be raised 32, or recessed 36. If the material does not adequately lend itself to molding, letters can be stamped or laminated 34.

FIG. 10 has an airfoil rim 20 similar to that in that in FIG. 8, but its inside wall 22 is much smaller and the curve is more concave. FIG. 10 also shows an example of notches 30 on the edge of the top rim 10. An unlimited number of patterns of notching 30 can be cut into the top rim 10 via the mold or cut directly into the plastic. The purpose of these notches 30 is to create sounds such as whirring or whistling when the unit flies through the air with a CD 28 attached.

### Operation—Preferred Embodiment

The CD or DVD 28 is inserted with the fingers between the upper lip 12 and lower lip 14 into the gripping mouth 16 of the lipped airfoil ring. The plastic material used for the top rim 10 of the airfoil ring is flexible enough to make insertion easy. The airfoil ring with attached CD or DVD 28 is then tossed horizontally through the air with a flick of the wrist, much as a person would toss the traditional “flying saucer” or, more commonly in recent years, the Frisbee ®. The unit will fly through the air in a manner dependent upon the angle and force with which it was tossed. It spins as it flies. Because of the shape and forward spinning motion of the airfoil rim 20, the ring and attached CD or DVD 28 will trap air in the airfoil underside as it spins through the air. The better it traps air, the better the airfoil lift. Good airfoil lift can mean the ring has more controllability, flies longer and achieves better distance at a slower speed. The slower it flies, the more gently it hovers and floats. When it floats gently, it is easier to catch. Good airfoil lift also will allow the ring to catch air currents.

### Operation—Alternative Embodiments

Alternative embodiments produce variant flight characteristics. The airfoil rim 20 in FIG. 4 is heavier than the preferred embodiment. Because of its shape and weight, between 45 and 55 grams without the CD or DVD 28 attached, it can be thrown harder and sails farther. While this embodiment achieves maximum distance, it sacrifices controllability and has limited hoverability. The foam plastic material used on the airfoil rim 20 still creates soft impact.

The ring with attached CD in FIG. 5 has more curve on the underside of the airfoil rim 20, and has a longer outside edge. These modifications will give it more lift, longer sailing time and longer sailing distance capability (depending on the force with which it is tossed). This shape also has increased controllability over that in FIG. 4.

The shape of the airfoil rim 20, illustrated in FIG. 6 causes it to catch air very efficiently. This creates increased ability to hover and ride air currents. The airfoil ring's controllability is also increased over that in FIG. 4, and flight speed is decreased. Distance is achieved at a slower speed.

FIG. 7 shows an airfoil rim that is lightweight and has good hoverability and lift. However, if this embodiment is fabricated using a mold, the shape of the airfoil rim 20 causes it to be slightly more difficult to remove from the mold.

FIG. 8 behaves in much the same manner as the preferred embodiment, but is slightly heavier. This helps it fly faster, but it does not hover quite as readily.

The airfoil rim 20 in FIG. 9A creates significant lift, which increases hoverability but sacrifices distance. In all embodiments, better hoverability creates more controllability. This embodiment displays both hoverability and controllability.

FIG. 10 shows a notched edge 30 on the outer periphery of the top rim 10. There is a wide variety of possible notching and cutout patterns, each creating its own effect. The notches and cutouts, when spinning through the air create whistling and whirring sounds without significantly affecting flight characteristics.

If lipped airfoil rings are being used to distribute music, advertising, or any other information or entertainment, measures need to be take to protect the CD from scratches or other damage. This is especially true if CD's are being thrown into crowds at music or sporting events. The CD is covered with a plastic film (shrink-wrapped) before it is inserted into the lipped airfoil ring. It can also be inserted between thin clear plastic protective sheets the same shape and size as the CD. If the CD being used is a discarded CD being tossed around in the lipped airfoil ring as a toy, protective plastic is unnecessary.

### Advantages

From the description above, a number of advantages of the lipped airfoil ring become evident:

(a) CD's and DVD's are tossed around simply because their circular, flat shape is conducive to that type of play. These discs, in their present form, must travel through the air at very high speeds to stay aloft. By design, there is nothing to keep the disc traveling horizontally through the air. They twist, turn and slam with considerable impact into whatever they hit, creating very high contact forces. This is due to a very small and sharp contact area on the outer edge of the disc. Injury or property damage is inevitable. The use of the lipped airfoil ring makes tossing CD's and DVD's very safe. Injury and property damage will be almost completely eliminated because the foam plastic airfoil rim is soft on impact. It will not hurt if it hits a child. If used responsibly, it will not damage walls or furniture if used indoors. In addition, because it floats and hovers more slowly, it is much easier and safer to catch.

(b) Any CD or DVD, be it advertising, recorded music or movies, product catalogs, software applications, or storage files, will easily fit in the lipped airfoil ring. Thus, any type of CD or DVD can be distributed using lipped airfoil rings.

(c) Unusable, discarded or obsolete CD's or DVD's will now have a use. They will become reusable, or, by definition, recyclable.

(d) Large sporting or music events have been seen by advertisers as having great potential for mass distribution of promotional material in the form of CD's and DVD's. Where they were once reluctant due to the danger of injuries, advertisers can comfortably toss the discs with attached lipped airfoil rings without fear of serious problems. Several reasons this is advantageous to the advertiser are:

a. when tossed into a crowd, the advertising CD's with airfoil rings are not likely to be discarded. Attractive, fun give-aways are much more likely to be kept in circulation. They can be tossed from one consumer to the next, which puts them in an ever-increasing number of consumer hands at no extra cost to the advertiser.

b. the lipped airfoil ring can have an advertiser's name, logo, trademark, brand, colors, website, phone numbers, or any other pertinent information or message molded or stamped onto the top rim. When it is continuously circulated among consumers, brand name recognition is continually reinforced and advertising dollars are maximized.

c. large numbers of consumers can be reached in a very short amount of time and at relatively little expense.

(e) Products of this nature with trademarks, celebrity names, event names, event dates, etc., often become collectible. As such, they may be traded, sold, and often displayed. They are not discarded, and brand name recognition is again reinforced.

(f) CD's that come in the mail will no longer be considered “junk mail”. They will be used over and over as safe toys.

(g) CD's and DVD's can be tossed by children or adults outside or inside without fear, if used responsibly, of damaging furniture, walls, or anything else in their paths.

(h) the CD or DVD is an item with limited, but essential function, currently information storage and recording. As soon as it becomes obsolete, it is replaced and discarded. The lipped airfoil ring provides a way to turn the obsolete CD into a new, safe toy for both children and adults. It is suitable for play in almost any environment, inside or outside, with unlimited new uses such as:

a. tossing the CD or DVD with attached airfoil ring back and forth between two (or more) people.

b. tossing it at a target or target receptacle.

c. tossing it in various ways that cause it to perform stunts or tricks.

d. it can be modified during manufacture, or a person can modify it at home with notching, cutouts, or any other conversion or adjustment. Such modifications may cause it to fly in different patterns, make sounds as it flies, or perform various stunts or tricks.

e. it may be safely used, with or without modification, competitively. This could be much the same as a yo-yo competition or Frisbee® competition. Or, if a target receptacle is used, team competition

such as modified basketball or modified soccer is a safe possibility.

### Conclusion, Ramifications, and Scope

Accordingly, the reader can see that the lipped airfoil can be used in a variety of ways to render CD's and DVD's safe, fun, recyclable, and profitable to advertisers. The invention is shown to have expanding scope in that

it eliminates injury and damage caused by the hard, sharp edge of the disc. In doing that, it makes possible a myriad of uses not stated in this application, such as new or alternate ways of playing with the disc, such as new games.

it permits advertisers to safely mass distribute promotional CD's and DVD's to crowds at large events. Because of the safety factor, many new, unstated, even as yet unconceived possibilities also exist in the arena of using the lipped airfoil ring attached to a CD or DVD for advertising and mass distribution.

it renders non-biodegradable or non-recyclable CD's and DVD's reusable, thus recyclable. Obsolete or “junk mail” CD's will be less likely to be discarded if they are attached to an airfoil ring. That which was once trash becomes a toy.

it provides a way for promotional CD's and DVD's to remain in circulation among consumers. This maximizes brand name recognition and minimizes advertising expense.

it makes CD's and DVD's much easier to catch in mass distribution situations or play situations. This is due to the capability of the airfoil rim to hover, float, and achieve distance at a slower speed.

it lends itself to unlimited modifications which create new properties and possible new uses. Some of this may include stunt or trick flying, or competitive flying.

Although the descriptions above and in previous sections contain many specifications, these should not be construed as limiting the scope of the invention but as merely providing illustrations of some of the preferred embodiments of this invention. For example, the airfoil rim can have many other shapes or sizes, and the size of the top rim can vary in both width and thickness.

Thus, the scope of the invention should be determined by the appended claims and their legal equivalents, rather than by the examples given.

We claim:

1. An annular protective rim attachment for compact discs and digital video discs, commonly referred to as CD's and DVD's, and herein referred to as discs, for rendering said discs tossable and catchable while maintaining maximum safety and controllability comprising:

2. the rim attachment of claim 1, wherein said rim consists of a means for gripping the outer periphery of said disc,
and,

3. the gripping means of claim 2, wherein said rim consists of a flexible gripping device, consisting of annularly parallel lips, which grip and hold said disc in place within its aperture, and said gripping device being disposed on the inner periphery of said annular rim,
and

4. the gripping device of claim 3, wherein said rim being generally flat on the top side with predetermined width, thickness and cross-sectional shape,
and

5. the rim attachment in claim 1, wherein said rim consists of an underside with predetermined width, thickness and cross-sectional shape so as to create an airfoil that when attached to said disc, creates a means of lift and consequent flight with controllability when tossed into the air by a human,
and,

6. the rim attachment in claim 1, wherein said rim being constructed of a material which is soft in order to lessen injury or damage resultant from contact impact, and said material being flexible in order to allow insertion and removal of said discs from said gripping device,
whereby said disc, which has a rigid, sharp edge, can be tossed and flown by a human with minimal risk of inflicting injury to said human or another human or animal, and with minimal risk of property damage, and
whereby a new use is established for said discs, rendering said discs recyclable.
